(19) United States
(12) Patent Application Publication
(10) Pub. No.: US 2009/0056225 A1
(43) Pub. Date: Mar. 5, 2009

(54) Process for Introducing Biomass Into a Conventional Refinery

(75) Inventor: William L. Schinski, San Rafael, CA (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Chevron U.S.A. Inc., San Ramon, CA (US)

(21) Appl. No.: 11/847,714

(22) Filed: Aug. 30, 2007

(51) Int. Cl. C01B 3/38

(52) U.S. Cl. 48/198.7

(57) ABSTRACT

The present invention is generally directed to methods and systems for processing biomass into usable products, wherein such methods and systems involve an integration into conventional refineries and/or conventional refinery processes. Such methods and systems provide for an enhanced ability to utilize biofuels efficiently, and they can, at least in some embodiments, be used in hybrid refineries alongside conventional refinery processes.

### FIELD OF THE INVENTION

This invention relates generally to methods and systems for processing biomass into usable products, and specifically to methods and systems for integrating such processing with conventional refineries, as well as to the hybrid refineries resulting therefrom.

### BACKGROUND

Many methods have been suggested for utilizing biofuel for energy production in order to compensate for at least a portion of the fossil fuel currently used in such energy production, and thereby also decrease net CO₂ emissions in the overall energy production cycle.

Unfortunately, biofeedstocks are generally considered to be low energy fuels, and not easily utilized for energy production. The low energy content of biomass renders it generally inadequate for high-efficiency production of energy, such as high-temperature, high-pressure steam or electricity. Additionally, non-uniformity in the raw material (i.e., biomass), differences in its quality, and other similar hard-to-control variations, may cause problems in an energy production cycle that relies heavily on such fuel.

In view of the foregoing, methods and/or systems for integrating biofuel synthesis with traditional refinery processes would be extremely useful—particularly wherein they serve to alleviate issues relating to biofuel raw materials (including their non-uniformity and variable production cycle).

### BRIEF DESCRIPTION OF THE INVENTION

The present invention is generally directed to methods and systems for processing biomass into usable products, wherein such methods and systems involve an integration into conventional refineries and/or conventional refinery processes. In some embodiments, the present invention is directed to the hybrid refineries resulting from such an integration.

In some embodiments, the present invention is directed to a method or process for introducing biomass into a conventional refinery, the process comprising the steps of: (1) co-feeding biomass and refinery residual material as a hybrid feedstock to a gasifier; (2) gasifying the hybrid feedstock in the gasifier to form syngas; and (3) processing the syngas to form a syngas-derived product, wherein at least some of the syngas-derived product (e.g., hydrocarbons, H₂, steam, power, etc.) is utilized in the conventional refinery.

In some or other embodiments, the present invention is directed to a system or hybrid refinery comprising: a conventional refinery operable for refining petroleum and a subsystem for converting biomass into a feed for the conventional refinery, wherein the subsystem comprises: (i) a means for co-feeding biomass and refinery residual material as a hybrid feedstock to a gasifier; (ii) a means for gasifying the hybrid feedstock within the gasifier to form syngas; and (iii) a means for processing the syngas to form a syngas-derived product, wherein at least some of the syngas-derived product is utilized in the conventional refinery; and further wherein said subsystem is integrated with one or more aspects of the conventional refinery.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts, in flow diagram form, a process for introducing/integrating biomass into a conventional refinery, in accordance with some embodiments of the present invention;

FIG. 2 is a schematic illustrating how a conventional refinery and a subsystem for processing biomass can be integrated as a hybrid refinery, in accordance with some embodiments of the present invention;

FIG. 3 is a schematic illustrating an exemplary hybrid refinery integration, wherein biomass (processed into pyrolysis oil) and refinery resid are co-fed into a gasifier, in accordance with some embodiments of the present invention;

FIG. 4 is a schematic illustrating another exemplary hybrid refinery integration, wherein biomass is fed into a short contact-time reformer, in accordance with some embodiments of the present invention;

FIG. 5 illustrates a short contact-time reformer, as used in some hybrid refinery system embodiments of the present invention;

FIG. 6 is a schematic illustrating another exemplary hybrid refinery integration, wherein biomass is fed into a short contact-time catalytic reformer (or other POX reformer) to produce syngas that is combined with syngas produced by processing refinery resid in an oxygen-fed, Flexi-coker or FCC regenerator unit, in accordance with some embodiments of the present invention;

FIG. 7 is a schematic illustrating high-pressure syngas conversion options, in accordance with some embodiments of the present invention; and

FIG. 8 is a schematic illustrating medium-pressure syngas conversion options, in accordance with some embodiments of the present invention.

### DETAILED DESCRIPTION OF THE INVENTION

As mentioned above, the present invention is generally directed to methods and systems for processing biomass into usable products and/or energy, wherein such methods and systems involve an integration into conventional refineries and/or conventional refinery processes. In some embodiments, the present invention is directed to the hybrid refineries resulting from such an integration. In some embodiments, the methods and systems of the present invention act to mitigate some of the issues (described above) associated with the processing of biomass (the raw materials) into biofuels and/or associated products.

### 1. DEFINITIONS

Certain terms are defined throughout this description as they are first used, while certain other terms used in this description are defined below:

“Biofuel,” as defined herein, is a fuel product at least partly derived from “biomass,” the latter being a renewable resource of biological origin. For the purposes of this invention, this term is further broadened to include “municipal solid waste” (“MSW”)—regardless of whether or not the MSW is of direct biological origin.

A “conventional refinery,” as defined herein, generally refers to an oil refinery, or aspects thereof, where crude oil (or other fossil fuels such as coal or natural gas) is processed. Processes carried out at such refineries include, but are not limited to, reforming, cracking, distilling, and the like.

“Refinery residual,” or “refinery resid,” as defined herein, generally refers to the heaviest by-product fractions produced at a refinery. Asphaltenes are a type of refinery resid, as is coker coke.

A “feedstock,” within the context of a refinery, and as used herein, refers to hydrocarbonaceous material fed into one or more refinery processes in order to make a fuel or other commercial product.

A “gasifier,” as defined herein, refers to a reaction environment wherein condensed hydrocarbonaceous feedstock material is converted into a gas through the action of heat and, possibly, one or more reactive gases such as oxygen, air, carbon dioxide (CO₂), and/or steam.

“Synthesis gas,” or “syngas,” as defined herein, generally refers to a mixture of carbon monoxide (CO) and hydrogen (H₂) produced by gasification in a gasifier.

Steam reforming of coal yields syngas according to the following equation:

C+H₂O→H₂+CO

Steam reforming of natural gas yields syngas according to the following reaction:

CH₄+H₂O→CO+3H₂

General oxidative routes from hydrocarbons to syngas are as follows:

CₙH₍₂ₙ₊₂₎+(n/2)O₂→nCO+(n+1)H₂

As mentioned above, syngas can be catalytically-converted to paraffins (alkanes) via a catalytic Fischer-Tropsch (FT) process:

nCO+(2n+1)H₂→CₙH₍₂ₙ₊₂₎+nH₂O

where typical catalysts include iron and cobalt. Examples of the Fisher-Tropsch process are described in U.S. Pat. No. 6,846,402.

In addition to the reactions shown above, it is worth noting that CO from syngas can undergo a “water-gas shift (WGS)” reaction to produce CO₂ and H₂:

CO+H₂O→CO₂+H₂

“Pyrolyzing,” as defined herein, refers to a thermal processing and/or thermal decomposition of hydrocarbonaceous material, wherein said decomposition is typically carried out in a non-oxidative environment.

“Pyrolysis oil,” as defined herein, refers to a liquid hydrocarbon product resulting from the pyrolyzing treatment of hydrocarbonaceous material.

A “hybrid refinery,” as defined herein, refers to a conventional refinery (or aspects thereof) that has been at least partially integrated (or otherwise associated) with a subsystem for the processing of a biomass feedstock.

“Syncrude” or “synthesis crude,” as defined herein, refers to a hydrocarbon-based oil made from syngas using a Fischer-Tropsch or Isosynthesis process or variants thereof.

### 2. METHODS

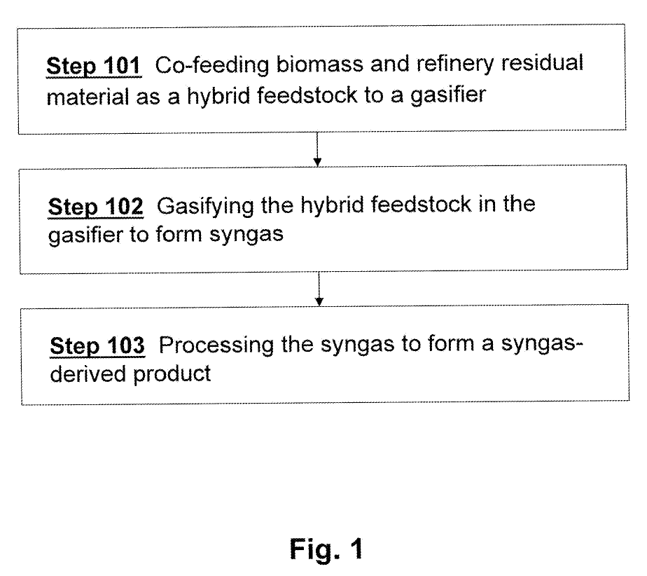

Referring to FIG. 1, in some embodiments, the present invention is directed to a method or process for introducing biomass into a conventional refinery, the process comprising the steps of: (Step 101) co-feeding biomass and refinery residual material as a hybrid feedstock to a gasifier; (Step 102) gasifying the hybrid feedstock in the gasifier to form syngas; and (Step 103) processing the syngas to form a syngas-derived product; wherein at least some of the syngas-derived product is utilized in the conventional refinery. The syngas-derived product may comprise a variety of consituents including, but not limited to, hydrocarbons, H₂, water (steam), power, and the like.

In some such above-mentioned method embodiments, such feedstocks for conventional refinery processes include, but are not limited to, fossil feedstocks, crude oil, tar sands, shale oil, coal, natural gas, combinations thereof, and the like. In some embodiments, the refinery residual material comprises asphaltenes and/or tars or other low-value carbonaceous by-product streams.

In some such above-mentioned method embodiments, such biomass can include, but not be limited to, agricultural feedstocks, forestry-based feedstocks, municipal solid waste, combinations thereof, and the like. In some such embodiments, wherein the biomass comprises municipal solid waste (MSW), the municipal solid waste can include, but not be limited to, waste plastics, used tires, paper, scrap-wood, food-processing waste, sewage, sludge, green-waste, combinations thereof, and the like.

In some such above-mentioned method embodiments, the method/process further comprises a step of pyrolyzing at least some of the biomass to form pyrolysis oil (py-oil), wherein the pyrolysis oil is co-fed to the gasifier with the refinery residual material. Typically, the step of pyrolyzing is carried out in a non-oxidative environment. In some such embodiments, the hybrid feedstock fed to the gasifier generally comprises from at least about 1 weight percent pyrolysis oil to at most about 99 percent pyrolysis oil, and more typically from at least about 5 weight percent pyrolysis oil to at most about 90 percent pyrolysis oil.

In some such above-mentioned method embodiments, the biomass typically comprises at least about 5 weight percent water, more typically at least about 10 weight percent water, and most typically between 20 and 30 weight percent water.

As mentioned above, the biomass can contain a significant amount of water. Note that in some embodiments, a synergy between the biomass and the residual material and/or coke is exploited. In such embodiments, water from the biomass displaces steam (fully or in part) that is normally required for coal, coke or residual material gasification to form the H₂ component of syngas.

In some such above-mentioned method embodiments, the step of gasifying comprises a gasifier of a type selected from the group consisting of partial oxidation gasifier, a steam reformer, an autothermal reformer, and combinations thereof (although other gasifier types can also be used). In some such embodiments, the gasifier utilizes oxygen separated from air using a technique selected from the group consisting of cryogenic separation (cryo-O₂), pressure-swing absorption, membrane separation (e.g., ion-transport membrane, ITM), and combinations thereof. In some such embodiments, when the gasifier is a partial oxidation gasifier, the partial oxidation gasifier is a short-contact time catalytic reformer. In some cases, the partial oxidation gasifier utilizes an oxidizing gas selected from the group consisting of air, oxygen-enriched air, pure oxygen, and combinations thereof.

In some such above-mentioned method embodiments, the syngas-derived product is selected from the group consisting of H₂, syncrude, hydrocarbons, oxygenates (e.g., alcohols and ethers), olefins, and combinations thereof. In some such embodiments, wherein the syngas-derived product comprises H₂, at least some of the H₂ is used in hydroprocessing operations within the (conventional) refinery. In some or other embodiments, steam and/or power produced directly or indirectly from the syngas can be at least partially directed into the conventional refinery.

In some such embodiments, where the syngas-derived product is or comprises syncrude, the syncrude is used analogously as crude. In some such embodiments, wherein the syngas-derived product comprises oxygenates, at least some of the oxygenates are converted to olefins and oligomerized. Note that F-T processes can also make olefins directly, and that these can be oligomerized too.

In some such above-mentioned method embodiments, there further comprises a step of conditioning the syngas prior to its processing, wherein such conditioning can comprise modulating the syngas by varying its H₂:CO ratio and/or removing impurities and/or diluents. In such or other embodiments, such conditioning can comprise compression, as appropriate for biofuel synthesis.

### 3. HYBRID REFINERIES

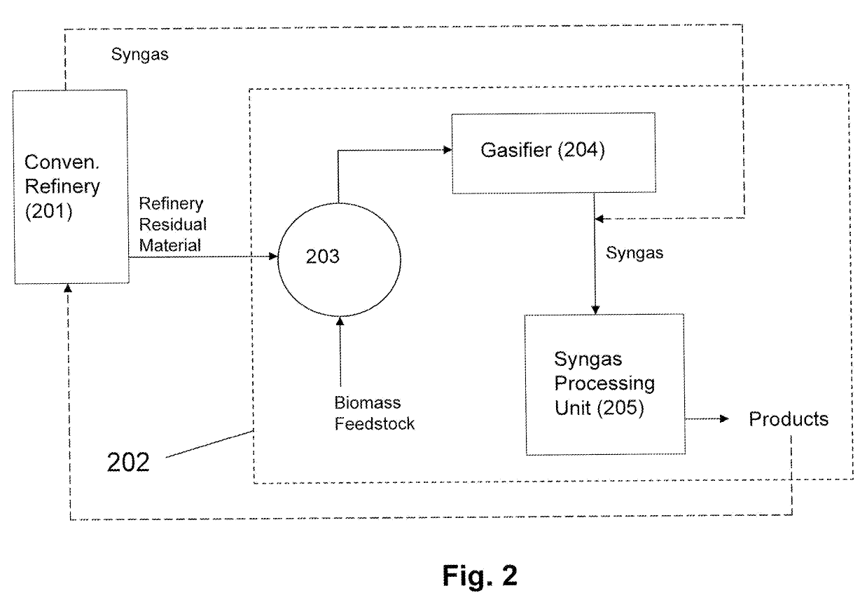

Referring to FIG. 2, in some embodiments, the present invention is directed to a system or hybrid refinery comprising: a conventional refinery (201) operable for refining petroleum; and a subsystem (202) for converting biomass into a feed for the conventional refinery, wherein the subsystem itself comprises: a means 203 for co-feeding biomass and refinery residual material as a hybrid feedstock to a gasifier; a means 204 for gasifying the hybrid feedstock within the gasifier to form syngas; and a means 205 for processing the syngas to form a syngas-derived product, wherein at least some of the syngas-derived product is utilized, as the above-mentioned feed, in the conventional refinery; wherein said subsystem is integrated with one or more aspects of the conventional refinery. Typically, in such embodiments, the conventional refinery comprises elements used in the conventional processing of petroleum. Still referring to FIG. 2, optional interdependencies are indicated by the dotted arrows, where syngas from the conventional refinery can be mixed with syngas from gasifier 204, and where products can be channeled back into refinery 201 for further processing and/or other uses.

In some such above-mentioned hybrid refinery embodiments, the means for co-feeding comprises an assembly for merging streams of biomass and refinery residual. In some such embodiments, the streams are combined before entering the gasifier. In other such embodiments, the streams are combined in the gasifier. In some embodiments, at least one of the biomass and refinery residual streams comprises a slurry. In some embodiments, the biomass stream comprises py-oil, the py-oil being derived from biomass. Conversion to py-oil facilitates gasification at pressures significantly higher than ambient. In some embodiments, the refinery resid stream comprises one or more of asphaltenes, coke, and tar.

As mentioned above, the means for gasifying the biomass and refinery residual streams comprises a gasifier. In some such hybrid refinery embodiments, the gasifier is selected from the group consisting of a partial oxidation (POX) gasifier, a steam reformer, an autothermal reformer, and combinations thereof. An exemplary POX gasifier is a short contact-time reformer.

In some such above-mentioned hybrid refinery embodiments, the means for processing the syngas comprises a method selected from the group consisting of water-gas shift, Fischer-Tropsch, isosynthesis, oxygenate-generating processes, and combinations thereof (other syngas processing routes can be additionally or alternatively employed). In some or other such embodiments, the syngas-derived product is selected from the group consisting of H₂, syncrude, hydrocarbons, oxygenates (e.g., alcohols and ethers). Note that steam and/or electrical power can be generated directly and/or indirectly from the syngas, and that some or all of such steam and/or power can be directed back into the conventional refinery for use in one or more processes or attributes associated therewith.

In some such above-mentioned hybrid refinery embodiments, at least some processes of the conventional refinery and the subsystem for converting biomass are interdependent. In some such embodiments, this interdependency fosters a supply-tolerant system. For example, feed streams can be modulated across the conventional refinery-subsystem boundary (physical and/or virtual) to accommodate increases or decreases of other feeds going to the conventional refinery.

### 4. EXAMPLES

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### Example 1

This Example serves to illustrate an exemplary hybrid refinery integration, wherein biomass (as pyrolysis oil) and refinery resid are co-fed into a gasifier, in accordance with some embodiments of the present invention.

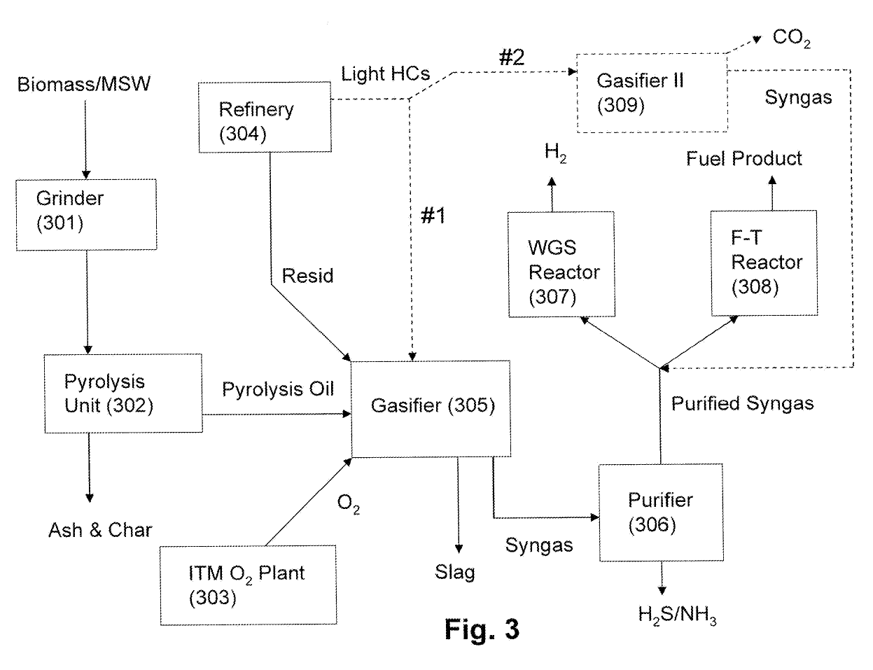

Referring to FIG. 3, biomass and/or municipal solid waste (MSW) is processed first in a grinder 301 and then pyrolyzed in pyrolysis unit 302 to form pyrolysis oil (py-oil). The py-oil is co-fed into gasifier 305 with resid (and/or heavy crude) from refinery 304 and oxygen (O₂) from an air separation plant, such as an ion-transport membrane (ITM) O₂ plant, 303, and syngas is produced (note that a portion of the py-oil can be fed directly into the refinery for conventional processing). The syngas is purified by means known to those of skill in the art, and depicted as purification means 306, to remove any H₂S and/or NH₃ present. Purified syngas is then passed into a water-gas shift (WGS) reactor 307 used to produce H₂ (which can be further utilized in other refinery processes), and/or it can be directed to a Fischer-Tropsch (F-T) reactor 308 where it is converted into a fuel intermediate or product. Optionally, light refinery hydrocarbons (HCs) can be co-fed into gasifier 305 (path #1), and/or they can be converted to syngas and purified in gasifier II 309 and subsequently introduced into WGS reactor 307 and/or F-T reactor 308—as indicated by the dotted line(s). Waste streams can include pyro-ash, gasifier slag, CO₂, and trace H₂S and NH₃.

### Example 2

This Example serves to illustrate an exemplary hybrid refinery integration, wherein biomass is fed into a short contact-time reformer, in accordance with some embodiments of the present invention.

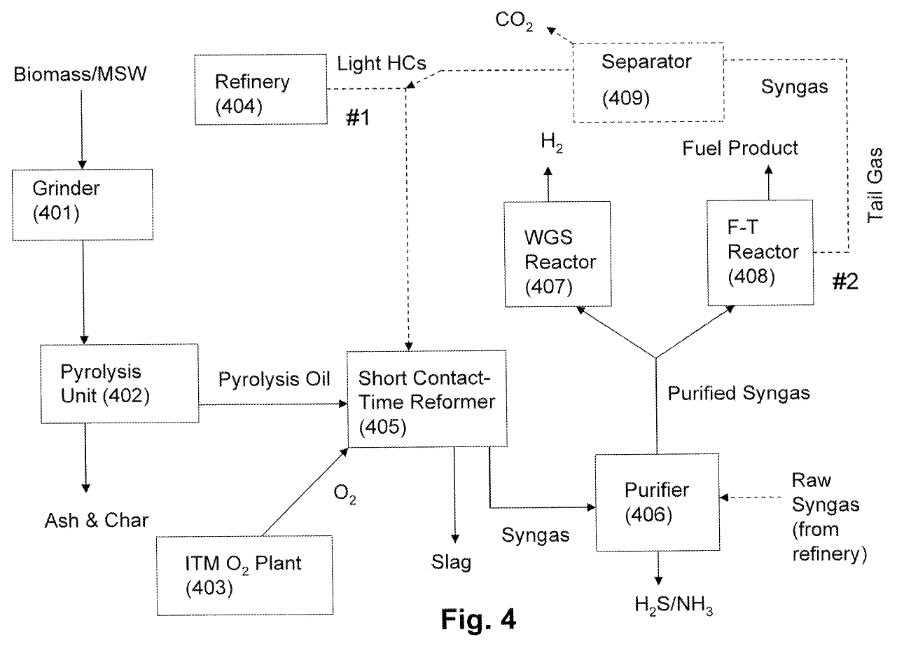

Referring to FIG. 4, biomass and/or MSW is processed in grinder 401 and then pyrolyzed in pyrolysis unit 402 to yield py-oil. The py-oil is then introduced into short contact-time reformer 405 with O₂, for example, from ion-transport membrane (ITM) oxygen plant 403. The syngas thus produced is purified of H₂S and NH₃ in purifier 406. The purified syngas can then be directed to WGS reactor 407 to produce H₂ and/or it can be directed to F-T reactor 408 to produce a hydrocarbon product. Optionally, light HCs from refinery 404 can be co-fed into the short contact-time reformer 405 (path #1) and/or tail gas from F-T reactor 408 can be so co-fed with CO₂ removal via separator 409 (path #2). Hydrogen produced in WGS reactor 407 can further be used in other refinery processes. Waste streams can include pyro-ash, CO₂, and trace H₂S and NH₃. See, e.g., Salge et al., “Renewable Hydrogen from Nonvolatile Fuels by Reactive Flash Volatilization,” Science, vol. 314, pp. 801-804, 2006.

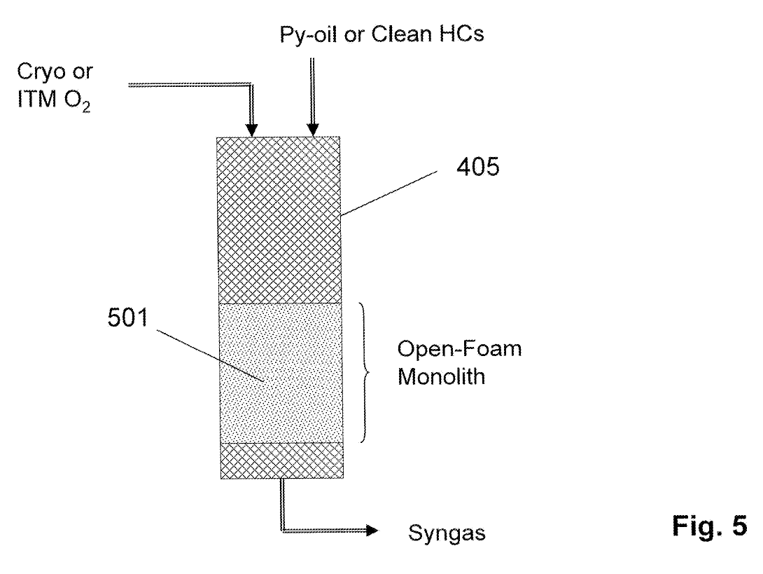

Short contact-time reformer 405 is further illustrated in FIG. 5, wherein cryogenic or ITM O₂ is introduced along with py-oil or clean (no sulfur) HCs into reformer 405 and these species are reacted in catalyst zone 501 to produce syngas. Note that the py-oil is expected to contain some low level of sulfur, and thus the catalyst in the short contact-time reformer must either accommodate the sulfur or the py-oil must be pre-treated. Note also that zone 501 is generally an open-foam monolith supporting catalyst species such as Pt metal. This type of reformer requires a lower capital expenditure (CAPEX) than a gasifier, but typically will not handle non-volatile inorganic species in the feed.

### Example 3

This Example serves to illustrate an exemplary hybrid refinery integration, wherein biomass is fed into a short contact-time reformer to produce syngas that is combined with syngas produced by processing refinery resid in a flexi-coker whose regeneration section is fed oxygen, in accordance with some embodiments of the present invention.

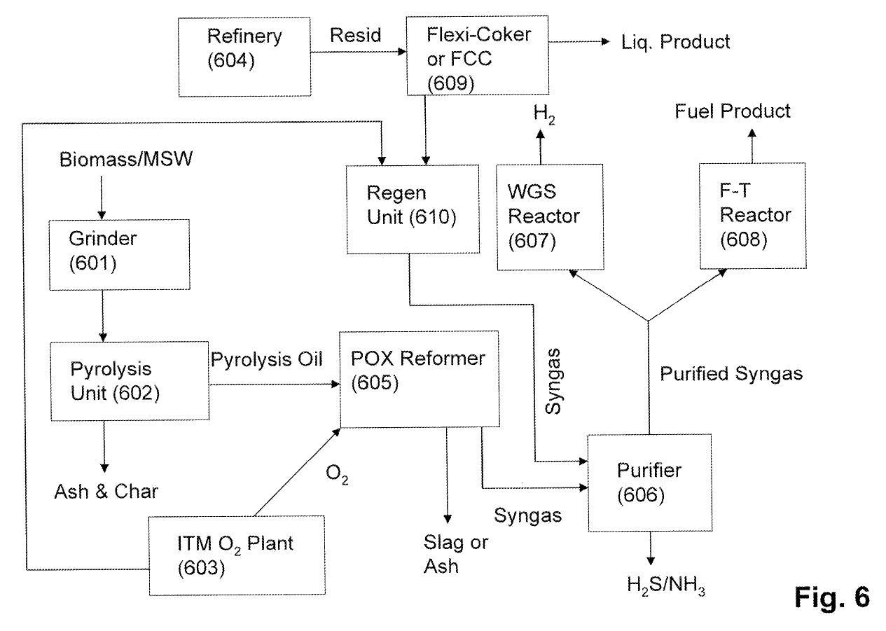

Referring to FIG. 6, biomass and/or MSW fed into grinder 601 and then into pyrolysis unit 602 where it is converted to py-oil. The py-oil is transferred into a short contact-time reformer 605 (other partial oxidation reformer types could alternatively be used), along with O₂ from ITM O₂ plant 603, where it is converted to syngas. Simultaneously or concurrently, resid from refinery 604 is processed in flexi-coker or fluid catalytic cracker (FCC) 609, the liquid product of which is transferred to regeneration unit 610, along with O₂ from ITM O₂ plant 603, to make syngas. See, e.g., Hammond et al., “Review of Fluid Coking and Flexicoking Technology,” Amer. Inst. of Chem. Eng., 2003 Spring National Meeting, Apr. 2, 2003. The two separate syngas streams are then passed through purifier 606 to remove H₂S and NH₃. The purified syngas that is produced is then passed into a water-gas shift (WGS) reactor 607 used to produce H₂ (which can be further utilized in other refinery processes), and/or it can be directed to a Fischer-Tropsch (F-T) reactor 608 where it is converted into a fuel product. Alternatively, all or part of the syngas may be used to generate power or steam. Waste streams can include pyro-ash, CO₂, and trace H₂S and NH₃.

### Example 4

This Example serves to illustrate high-pressure syngas conversion options, in accordance with some embodiments of the present invention.

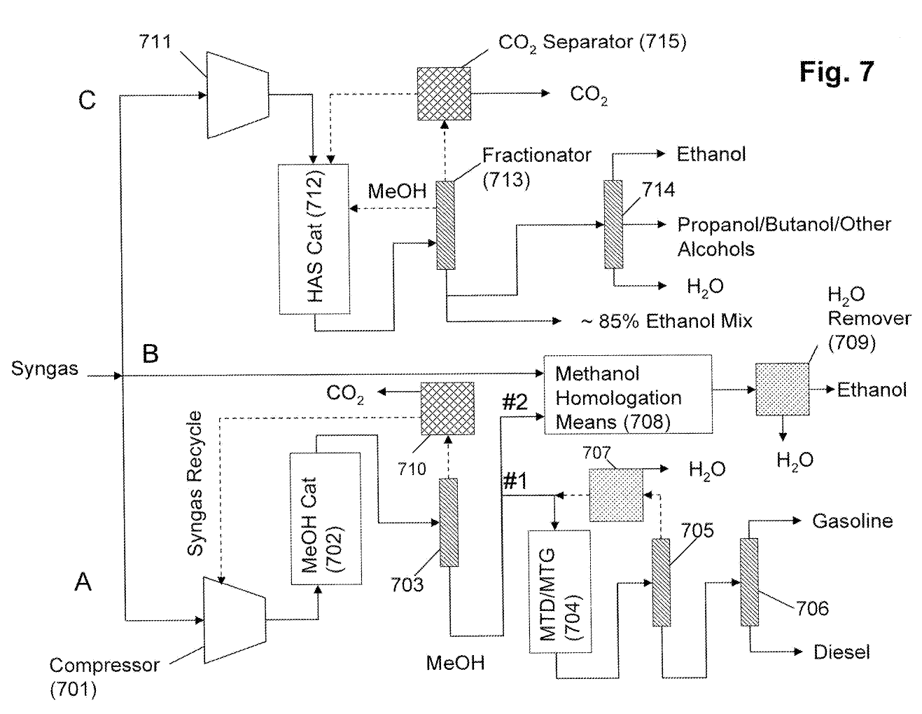

Referring now to FIG. 7, syngas produced according to one or more embodiments of the present invention can be further processed via any or all of streams A-C.

In stream A, syngas is pressurized by compressor 701 and then fed into methanol (MeOH) catalytic unit 702 to produce a methanol-containing product which is fed into fractionator 703. Methanol emanates from said fractionator and can follow one or both of two paths. In path #1, the methanol is fed into a combined methanol-to-diesel (MTD)/methanol-to-gasoline (MTG) unit 704. See, e.g., Keil, “Methanol-to-Hydrocarbons: Process Technology,” Microporous and Mesoporous Materials, vol. 29, pp. 49-66, 1999. The product that results is then passed through fractionators 705 and 706, after which it can be collected separately as gasoline and diesel. The lighter fractions resulting from fractionator 705 can be passed through purifier 707 to remove water and then recycled back into unit 704 (largely as methanol). In path #2, methanol is additionally or alternatively passed into methanol homologation means 708 (see, e.g., U.S. Pat. No. 4,239,925), along with syngas from stream B. The ethanol-containing product is then processed through H₂O remover 709 to yield ethanol.

In stream C, syngas is pressurized by compressor 711 and passed into higher alcohol synthesis (HAS) catalytic unit 712 where it is converted into mixed alcohols. The mixed alcohols can then be passed through fractionator 713 to yield a predominately (˜85%) ethanol product mix. This can be further processed in fractionator 714 to separate out water and other alcohols and produce relatively pure ethanol. Optionally, methanol can be extracted from fractionator 713 and cycled back to HAS unit 712. Other species, e.g., unconverted syngas, extracted by fractionator 713 can be passed through separator 715 and cycled back into the HAS unit as well.

### Example 5

This Example serves to illustrate medium-pressure syngas conversion options, in accordance with some embodiments of the present invention.

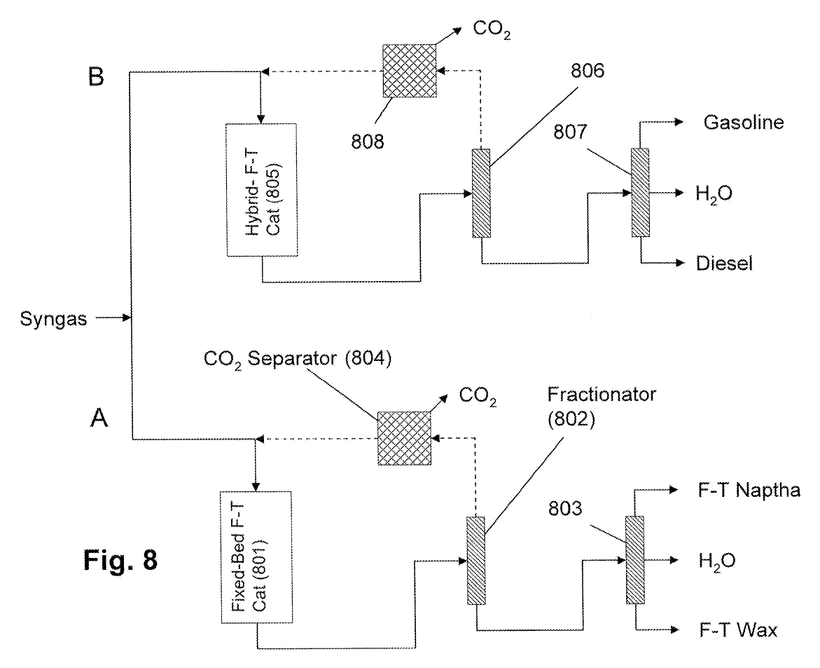

Referring now to FIG. 8, syngas produced according to one or more embodiments of the present invention can be further processed via one or both of streams A and B.

In stream A, syngas is passed through a fixed-bed Fischer-Tropsch (F-T) catalytic reactor unit 801 to produce a hydrocarbon-containing product. See, e.g., Dry, “Fischer-Tropsch Synthesis Over Iron Catalysts,” Catalysis Letters, vol. 7, pp. 241-252, 1990. This hydrocarbon-containing product is then passed through fractionator 802 (as a hydrocarbon stream) to remove gaseous species. After passing through fractionator 802, the hydrocarbon stream is further fractionated into F-T naphtha, water, and F-T wax in fractionator 803. Note that the F-T naphtha can be channeled to a refinery reformer or steam cracker and the F-T wax can be sent to a hydrocracker, thereby further integrating biomass processing with conventional refining. Optionally, the gaseous species removed from the hydrocarbon stream by fractionator 802 can be passed through a separator 804, to remove CO₂, and then recycled back into unit 801 as syngas.

Still referring to FIG. 8, syngas in stream B is passed into a hybrid F-T catalytic reactor unit 805. Similar to the fate of that of stream A, the resulting hydrocarbon stream is purified by passing it through fractionator 806 to remove gaseous species, and the purified hydrocarbon stream is then separated into gasoline, water, and diesel in fractionator 807. Also as in the case of stream A, the gaseous species can be passed through a separator 808 to remove CO₂, and the resulting gas recycled back into reactor unit 805 as syngas.

### 5. CONCLUSION

In summary, the present invention is directed generally to methods and systems for processing biomass into usable products—particularly where such methods and systems involve integrating such processing with conventional refineries.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed:

1. A process for introducing biomass into a conventional refinery, the process comprising the steps of:
a) co-feeding biomass and refinery residual material as a hybrid feedstock to a gasifier;
b) gasifying the hybrid feedstock in the gasifier to form syngas; and
c) processing at least some of the syngas to form a syngas-derived product, wherein at least some of the syngas-derived product is utilized in the conventional refinery.

2. The process of claim 1, wherein a conventional refinery processes feedstocks selected from the group consisting of fossil feedstocks, crude oil, tar sands, shale oil, coal, natural gas, and combinations thereof.

3. The process of claim 1, wherein the biomass is selected from the group consisting of agricultural feedstocks, forestry-based feedstocks, municipal solid waste, and combinations thereof.

4. The process of claim 3, wherein the biomass comprises municipal solid waste, and wherein the municipal solid waste is selected from the group consisting of waste plastics, used tires, paper, scrap-wood, food-processing waste, sewage, sludge, green-waste, and combinations thereof.

5. The process of claim 1, wherein the refinery residual material comprises low-value carbonaceous by-products selected from the group consisting of asphaltenes, tars, and combinations thereof.

6. The process of claim 1 further comprising a step of pyrolyzing at least some of the biomass to form pyrolysis oil, wherein the pyrolysis oil is co-fed to the gasifier with the refinery residual material.

7. The process of claim 6, wherein the step of pyrolyzing is carried out in a non-oxidative environment.

8. The process of claim 6, wherein the hybrid feedstock fed to the gasifier comprises from at least about 1 weight percent pyrolysis oil to at most about 99 percent pyrolysis oil.

9. The process of claim 6, wherein the hybrid feedstock fed to the gasifier comprises from at least about 5 weight percent pyrolysis oil to at most about 90 percent pyrolysis oil.

10. The process of claim 1, wherein the biomass comprises at least about 5 weight percent water.

11. The process of claim 1, wherein the biomass comprises at least about 10 weight percent water.

12. The process of claim 1, wherein the step of gasifying comprises a gasifier selected from the group consisting of partial oxidation gasifier, a steam reformer, an autothermal reformer, and combinations thereof.

13. The process of claim 12, wherein the partial oxidation gasifier is a short-contact time catalytic reformer.

14. The process of claim 10, wherein the partial oxidation gasifier utilizes an oxidizing gas selected from the group consisting of air, oxygen-enriched air, pure oxygen, and combinations thereof.

15. The process of claim 10, wherein the gasifier utilizes oxygen separated from air using a technique selected from the group consisting of cryogenic separation, pressure-swing absorption, membrane separation, and combinations thereof.

16. The process of claim 1, wherein the syngas-derived product is selected from the group consisting of H₂, syncrude, hydrocarbons, oxygenates, olefins, and combinations thereof.

17. The process of claim 1, wherein at least some of the syngas-derived product comprises H₂, and wherein the H₂ is used in hydroprocessing within the refinery.

18. The process of claim 1, wherein at least some of the syngas-derived product is used for steam generation within the refinery.

19. The process of claim 1, wherein at least some of the syngas-derived product is used to generate electrical power.

20. The process of claim 1, wherein the syngas-derived product comprises syncrude, and wherein the syncrude is used analogously as crude.

21. The process of claim 1, wherein the syngas-derived product comprises oxygenates.

22. The process of claim 21, wherein at least some of the oxygenates are converted to olefins and oligomerized.

23. The process of claim 1, wherein the syngas-derived product comprises olefins suitable for oligomerization.

24. The process of claim 1 further comprising a step of conditioning the syngas prior to its processing, wherein the conditioning comprises modulating the syngas by varying its H₂:CO ratio.
